(19) United States
(12) Patent Application Publication
(10) Pub. No.: US 2006/0288550 A1
(43) Pub. Date: Dec. 28, 2006

(54) Robot arm having a wrist house movable mounted by holding means

(75) Inventor: Gorgen Johansson, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 10/558,832

(22) PCT Filed: Jun. 14, 2004
(86) PCT No.: PCT/SE04/00943

§ 371 Date: Nov. 29, 2005

(30) Foreign Application Priority Data
Jun. 13, 2003 (SE) 0301754-8

(51) Int. Cl. B23B 11/00

(52) U.S. Cl. 29/53

(57) ABSTRACT

An industrial robot including a robot arm having a wrist including a wrist housing that is movably mounted on the robot arm. The wrist housing includes a holder for pivotable connection in one degree of freedom of a rotary robot tool thereto.

### TECHNICAL FIELD

The invention relates to industrial robots.

### BACKGROUND ART

Conventional industrial robots comprise at least one robot arm having a wrist at its distal end. The wrist comprises a wrist-housing with supporting means, such as a fork-like extension, in which a tilt assembly is supported. The wrist rotates about a first axis that is parallel to the longitudinal centre line of the robot arm. The wrist also comprises a turning disc on which a robot tool, or other desired attachment is mounted. The turning disc is arranged to rotate about a second axis that is at an angle to the first axis on the turning disc in order to position the robot tool. Such an industrial robot is disclosed in U.S. Pat. No. 6,125,715, for example. A disadvantage with such a robot is that an offset exists between the centre of rotation of the turning disc and the robot tool, which gives the robot an undesired flexibility, which adversely affects its performance.

### SUMMARY OF THE INVENTION

The object of the invention is to provide an industrial robot having an improved tool support assembly.

This and other objects of the invention are achieved by an industrial robot comprising the features described in claim 1, namely an industrial robot comprising a robot arm having a wrist comprising a wrist housing that is movably mounted on the robot arm and comprising holding means for pivotable connection in one degree of freedom of a rotary robot tool thereto.

The rotary robot tool is therefore integrated with the robot wrist, which consequently greatly improves the rigidity of the tool-supporting robot arm and thus the rigidity and stability of the robot, consequently improving the performance of the inventive robot. Play between the turning disc and the rotary robot tool and offset between the centre of the turning disc and the centre of the rotary robot tool are eliminated by omitting the turning disc and mounting the rotary robot tool directly on the wrist. Furthermore the inventive robot is less expensive and easier to manufacture than a conventional robot.

The invention is applicable to any type of industrial robot comprising at least one movable or fixed robot arm having a wrist that is movably mounted on the robot arm. If an existing six-axis industrial robot is modified according to the invention, the inventive industrial robot will have only five axes, since the sixth axis is eliminated by replacing the turning disc with the rotary robot tool. For applications such as milling and friction stir welding, where the rotary tool-attachment held by the robot is symmetrical, the sixth axis has no function. It is therefore sufficient to utilize five axes and still have the same performance of reach.

According to an embodiment of the invention the rotary robot tool comprises driving means such as a motor and/or a gear assembly such as bevel gears.

According to another embodiment of the invention the holding means provide a rotary axis perpendicular to the rotary axis of the rotary robot tool so that the rotary robot tool is able to rotate at least up to 180° around the rotary axis provided by the holding means. According to an alternative embodiment of the invention the rotary axis of the rotary robot tool crosses the rotary axis provided by the holding means at an angle other than 90°.

According to another embodiment of the invention the wrist is mounted on an upper robot arm.

According to an embodiment of the invention the driving means is hydraulically driven in order to contain as much power as possible. According to another embodiment of the invention the driving means is electrically driven and is powered either by the industrial robot's power supply or by a separate power supply. The power supply is contained within the housing of rotary robot tool or, alternatively, power is supplied to the driving means of the rotary robot tool via cables drawn along the wrist and through the holding means from the robot's power supply.

According to a yet further embodiment of the invention the driving means is arranged to drive the rotary robot tool at constant rotational speed. Alternatively the driving means comprises means to vary its rotational speed.

According to an embodiment of the invention the rotary robot tool is a symmetric rotary robot tool such as a milling tool or a friction stir welding tool. The industrial robot according to the present invention is particularly, but not exclusively, suitable for carrying out a task such as milling or friction stir welding or any other type of work such as cutting, grinding, polishing or assembly work.

### BRIEF DESCRIPTION OF THE DRAWINGS

The invention will be explained in greater detail by description of embodiments with reference to the accompanying drawings, where

FIG. 1 shows an industrial robot according to a first embodiment of the invention,

FIG. 2 shows the wrist of an industrial robot directly holding a motor that drives a tool-attachment,

FIG. 3 shows a side view of the wrist with an integrated motor shown in FIG. 2,

FIG. 4 shows a tool support assembly according to an embodiment of the invention,

FIGS. 5a and 5b show tool support assembly according to other embodiments of the invention, and

FIG. 6 shows an industrial robot according to the prior art.

It should be noted that the figures have not been drawn to scale and that the size of certain features has been exaggerated for the sake of clarity.

### DESCRIPTION OF AN EMBODIMENT

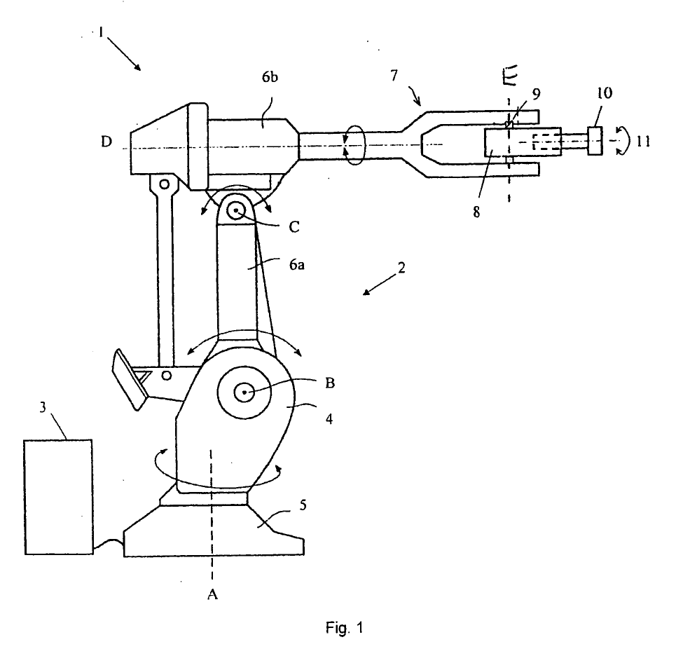

FIG. 1 shows an industrial robot 1 comprising a manipulator 2 and its control unit 3. The robot 1 has a stand 4 that is rotatably mounted on a robot foot 5, which enables it to rotate about vertical axis A. The robot 1 comprises a robot arm 6 constituted of a lower arm 6a and an upper arm 6b. The lower robot arm 6a is pivotably mounted about axis B and supports the robot's upper arm 6b. The lower and upper arms are pivoted about axis C. The upper arm 6b is rotatable about axis D that coincides with the longitudinal axis of the upper arm 6b.

A wrist 7 is mounted on the distal end of the upper arm 6b. The wrist 7 comprises holding means 9 for pivotable connection in one degree of freedom of a rotary robot tool comprising a spindle motor 8 that is arranged to drive a rotary tool-attachment. The spindle motor 8 has an adaptor 10 on which a rotary tool-attachment may be mounted. The rotary robot tool is a drill for example and the rotary tool-attachment is a drill bit. The drill comprises a power supply within the housing of drill. When powered, the output shaft of the spindle motor 8 causes the rotary robot tool to rotate about axis 11 at high speed. The rotational axis of the spindle motor 11 is at a 90° angle in relation to the rotational axis (E) provided by the holding means 9.

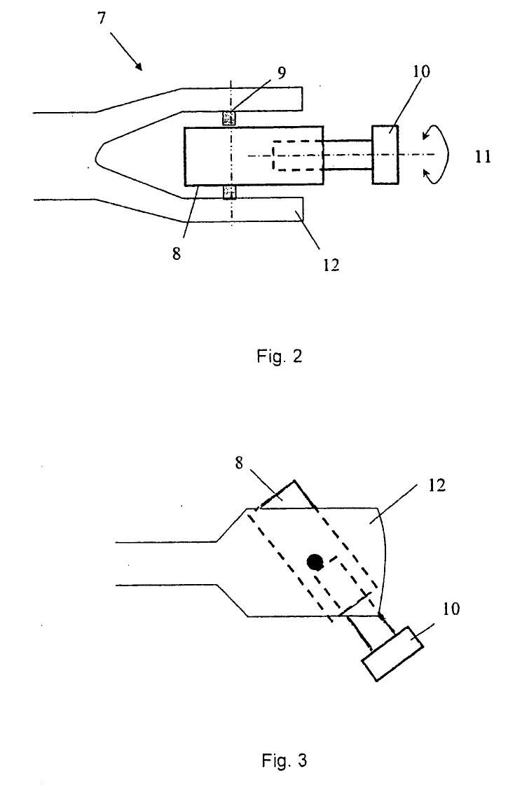

FIG. 2 shows a wrist 7 comprising supporting means in the form of a fork-like extension 12. The supporting means 12 hold a rotary robot tool comprising a spindle motor 8. The spindle motor 8 is pivotably mounted on the wrist supporting means 12 via holding means 9. The spindle motor 8 has an adaptor 10 on which a rotary tool-attachment is mounted.

FIG. 3 shows a side view of the wrist 7 with an integrated motor 8 shown in FIG. 2.

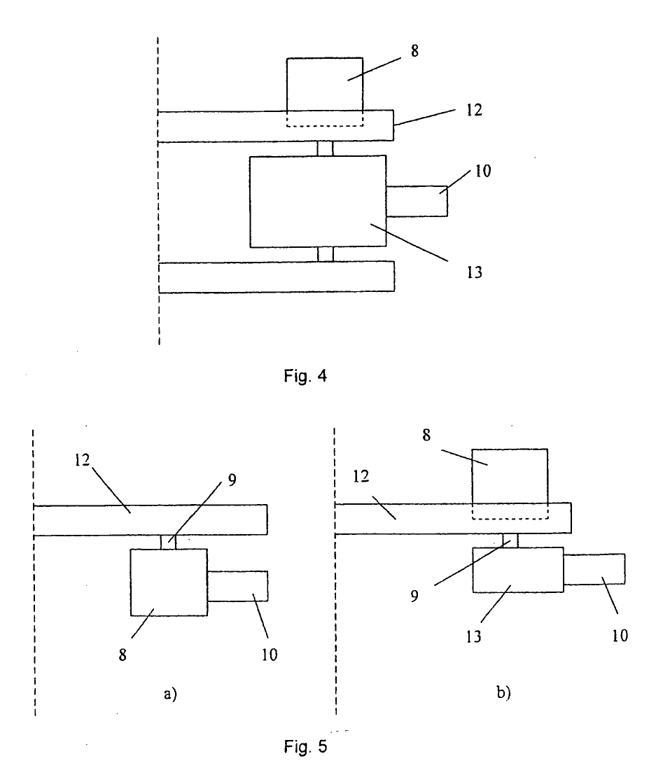

FIG. 4 shows a tool support assembly where bevel gears 13 are arranged between a motor 8 mounted on supporting means 12 and the adaptor 10.

FIG. 5a shows a tool support assembly where a motor 8 is mounted on the supporting means 12 via a single holding means 9. The motor 8 is housed within the housing of the robot tool. FIG. 5b shows a tool support assembly where bevel gears 13 are arranged between a motor 8 mounted on the supporting means 12 and the adaptor 10. The motor 8 is external to the housing of the robot tool.

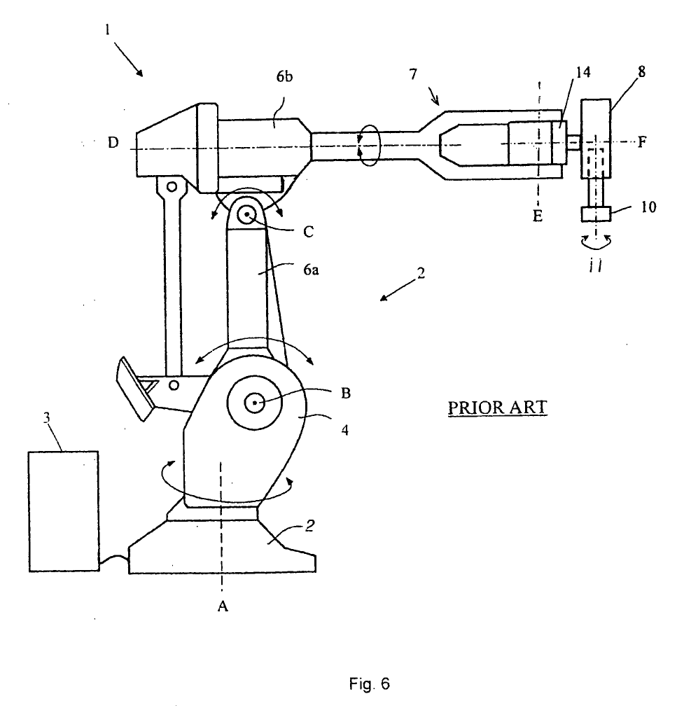

FIG. 6 shows a conventional six-axis (A,B,C,D,E and F) industrial robot according to the prior art. Reference FIGS. 1-7 represent the same features as in FIG. 1. The wrist 7 of the conventional robot comprises a turning disc 14. A rotary robot tool is mounted on the turning disc 14. The turning disc rotates about axis F in order to position the rotary robot tool. There is an offset between the centre of rotation of the turning disc 14 and the centre of rotation of the rotary robot tool. As can be seen by comparing FIGS. 1 and 6, the inventive robot (shown in FIG. 1) has only five axes A,B,C,D and E, the sixth (F) being replaced by the rotational axis 11 of the rotary robot tool.

The invention is not in any way restricted to the embodiments thereof described above, but many possibilities to modifications thereof would be apparent to a person with ordinary skill in the art without departing from the basic idea of the invention as defined in the appended claims.

1. An industrial robot comprising
a robot arm having a wrist comprising a wrist housing which is movably mounted on the robot arm, wherein the wrist housing comprises holding means for pivotable connection in one degree of freedom of a rotary robot tool thereto.

2. The industrial robot according to claim 1, wherein the rotary robot tool comprises driving means.

3. The industrial robot according to claim 1, wherein the holding means comprises a rotary axis that is perpendicular to the rotary axis of the rotary robot tool.

4. The industrial robot according to claim 1, wherein the rotary axis of the rotary robot tool crosses the rotary axis provided by the holding means at an angle other than 90°.

5. The industrial robot according to claim 1, wherein the wrist is rotatably mounted on the robot arm.

6. The industrial robot according to claim 1, wherein the wrist is mounted on an upper robot arm.

7. The industrial robot according to claim 2, wherein the driving means is hydraulically driven.

8. The industrial robot according to claim 2, wherein the driving means is electrically driven.

9. The industrial robot according to claim 8, wherein the driving means is powered by the industrial robot's power supply.

10. The industrial robot according to claim 8, wherein the driving means is powered by a separate power supply.

11. The industrial robot according to claim 2, wherein the driving means is arranged to drive the rotary robot tool at constant rotational speed.

12. The industrial robot according to claim 2, wherein the driving means comprises means to vary its rotational speed.

13. The industrial robot according to claim 1, wherein the rotary robot tool is a symmetric rotary robot tool.

14. The industrial robot according to claim 1, wherein the rotary robot tool is a milling tool.

15. The industrial robot according to claim 1, wherein the rotary robot tool is a friction stir welding tool.

16. The industrial robot according to claim 2, wherein the driving means comprises a motor.
